(19) United States
(12) Patent Application Publication
(10) Pub. No.: US 2006/0215291 A1
(43) Pub. Date: Sep. 28, 2006

(54) Data string searching

(76) Inventors: Glen Alan Jaquette, Tucson, AZ (US); Scott Jeffrey Schaffer, Tucson, AZ (US)

Correspondence Address: JOHN H. HOLCOMBE;IBM CORPORATION, IP LAW DEPT., 8987 E. TANQUE VERDE RD., #309-374, TUCSON, AZ, 85749, US

(21) Appl. No.: 11/089,622

(22) Filed: Mar. 24, 2005

(51) Int. Cl. G11B 20/10

(52) U.S. Cl. 360/39

(57) ABSTRACT

Searching data string matches, e.g. data stored on magnetic tape cartridges, and is searched by magnetic tape drives. String comparison engines are configured to search data and to indicate matches to search terms, and an identification engine is configured to identify patterns of the matches indicated by selected string comparison engines.

### FIELD OF THE INVENTION

This invention relates to searching for and identifying strings in data.

### BACKGROUND OF THE INVENTION

Searching for a given string of data in large sets of data has been solved by reading each set of data (or “record”) from the data storage, transferring the data to a server or host system which searches each and every record, typically in sequence. If the search is to be conducted on a large number of data storage magnetic tapes, the process can be very time and computationally consuming. Magnetic tape is typically a high capacity data storage, and typically compresses the data to increase the capacity further. For one magnetic tape drive and one server to read and then to search an entire set of magnetic tape cartridges could be prohibitively time consuming. For example, it might take as much as 2 hours to mount, load and then completely read and search a tape cartridge, and thus 1000 tape cartridges would take 2000 hours, or nearly 83 days. To reduce the time, multiple servers can be assigned to do the job in parallel. Another solution is to keep an index of the data as it is stored or catalogued. This is fine so long as the index covers all the terms of interest such that a server or host system can process the search against the index.

It has been suggested that, if the data were stored on hard disk drives for data mining, the hard disk drives would have low-level search intelligence, and the database application would break searches into individual commands, which would be sent simultaneously to all drives to conduct a direct search of the data. Substantial time is required to access, read and transfer the data from magnetic tape to the host and/or to hard disk drives, when the data is already stored on magnetic tape, and, further, many searches are not so simple.

### SUMMARY OF THE INVENTION

Logic, magnetic tape drives, and service methods are provided for searching data.

In one embodiment, a plurality of string comparison engines are configured to search data and to indicate matches to search terms; and an identification engine is configured to identify patterns of the matches indicated by selected string comparison engines.

In a further embodiment, the string comparison engines are configured to search a common set of data in parallel.

In a still further embodiment, at least one of the string comparison engines comprises at least one mask configured to modify specific search terms.

In another embodiment, at least one of the string comparison engines is configured to search the data on a byte-by-byte basis. In a further embodiment, at least one string comparison engine is configured to search the bytes of data employing a bit mask for each byte and a byte mask. In a still further embodiment, at least one string comparison engine is configured to search two consecutive bytes of the data in parallel.

In another embodiment, the identification engine comprises a Boolean look-up table.

In another embodiment, a magnetic tape drive comprises a tape drive system for moving a magnetic tape longitudinally; at least one read channel configured to read data recorded on a magnetic tape as the tape is moved longitudinally by the tape drive system; and a search engine configured to search data read by the read channel(s) and to identify matches of strings of data to search terms. In a further embodiment, the magnetic tape drive additionally comprises at least one decompressor configured to decompress the data read by the read channel(s); and the search engine is configured to search the decompressed data. The search engine may further comprise the embodiments of logic discussed above.

In another embodiment, a service method of searching data comprises searching a common set of data in parallel and indicating matches of strings of the data to search terms; and identifying patterns of selected matches.

In a further embodiment, the data is decompressed prior to searching; such that the searching comprises searching the decompressed data.

In a still further embodiment, the patterns are identified by looking-up patterns of selected matches in a Boolean look-up table.

In another embodiment, where the data is stored on a plurality of magnetic tape cartridges, data is read from magnetic tape cartridges in a plurality of magnetic tape drives; and the data is searched by the plurality of magnetic tape drives, indicating matches of strings, and the plurality of magnetic tape drives identify patterns of selected matches.

For a fuller understanding of the present invention, reference should be made to the following detailed description taken in conjunction with the accompanying drawings.

### BRIEF DESCRIPTION OF THE DRAWINGS

FIG. 1 is an isometric view of a magnetic tape cartridge with a magnetic tape shown in phantom;

FIG. 2 is a block diagrammatic representation of a magnetic tape drive for handling the magnetic tape cartridge of FIG. 1;

FIG. 3 is a block diagrammatic representation of a search engine of the magnetic tape drive of FIG. 2;

FIG. 4 is a block diagrammatic representation of a string comparison engine of FIG. 3;

FIGS. 5A and 5B are diagrammatic representations of operation of the string comparison engine of FIG. 4; and

FIG. 6 is a flow chart depicting an embodiment of a service method in accordance with the present invention.

### DETAILED DESCRIPTION OF THE INVENTION

This invention is described in preferred embodiments in the following description with reference to the Figures, in which like numbers represent the same or similar elements. While this invention is described in terms of the best mode for achieving this invention's objectives, it will be appreciated by those skilled in the art that variations may be accomplished in view of these teachings without deviating from the spirit or scope of the invention.

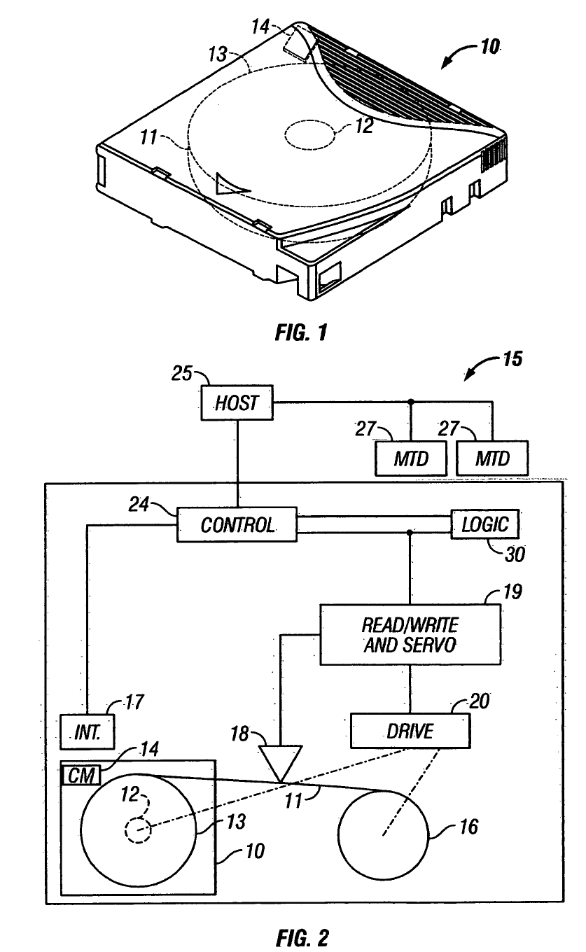

Referring to FIG. 1, an example of a magnetic tape cartridge 10 in which the present invention may be employed is illustrated which comprises a rewritable magnetic tape 11 wound on a hub 12 of reel 13, and optionally a cartridge memory 14. One example of a magnetic tape cartridge comprises a cartridge based on LTO (Linear Tape Open) technology. The illustrated magnetic tape cartridge is a single reel cartridge. Magnetic tape cartridges may also comprise dual reel cartridges in which the tape is fed between reels of the cartridge.

Referring to FIG. 2, a magnetic tape drive 15 is illustrated. One example of a magnetic tape drive in which the present invention may be employed is the IBM 3580 Ultrium magnetic tape drive based on LTO technology, with microcode, etc., to perform desired operations with respect to the magnetic tape cartridge 10. In the instant example, the magnetic tape 11 is wound on a reel 13 in the cartridge 10, and, when loaded in the magnetic tape drive 15, is fed between the cartridge reel and a take up reel 16 in the magnetic tape drive. Alternatively, both reels of a dual reel cartridge are driven to feed the magnetic tape between the reels. The magnetic tape drive optionally comprises a memory interface 17 for reading information from, and writing information to, the cartridge memory 14 of the magnetic tape cartridge 10.

A read/write system is provided for reading and writing information to the magnetic tape, and, for example, may comprise a read/write and servo head system 18 with a servo system for moving the head laterally of the magnetic tape 11, a read/write servo control 19, and a drive motor system 20 which moves the magnetic tape 11 longitudinally between the cartridge reel 13 and the take up reel 16 and across the read/write and servo head system 18. The read/write and servo control 19 controls the operation of the drive motor system 20 to move the magnetic tape 11 across the read/write and servo head system 18 at a desired velocity, and, in one example, determines the location of the read/write and servo head system with respect to the magnetic tape 11. In one example, the read/write and servo head system 18 and read/write and servo control 19 employ servo signals on the magnetic tape 11 to determine the location of the read/write and servo head system, and in another example, the read/write and servo control 19 employs at least one of the reels, such as by means of a tachometer, to determine the location of the read/write and servo head system with respect to the magnetic tape 11. The read/write and servo head system 18 and read/write and servo control 19 may comprise one or more read channels and one or more write channels, and may comprise hardware and any suitable form of logic, including a processor operated by software, or microcode, or firmware, or may comprise hardware logic, or a combination.

A control system 24 communicates with the memory interface 17, and communicates with the read/write system, e.g., at read/write and servo control 19. The control system 24 may comprise any suitable form of logic, including a processor operated by software, or microcode, or firmware, or may comprise hardware logic, or a combination.

The illustrated and alternative embodiments of magnetic tape drives are known to those of skill in the art, including those which employ dual reel cartridges.

The control system 24 typically communicates with one or more host systems 25, and operates the magnetic tape drive 15 in accordance with commands originating at a host. Alternatively, the magnetic tape drive 15 may form part of a subsystem, such as a library, and may also receive and respond to commands from the subsystem.

In one embodiment of the present invention, a search engine 30 is configured to search data read by the read channel(s) 18, 19 and to identify matches of strings of data to search terms. The search engine 30 may comprise any suitable form of logic, including hardware logic, such as VLSI, a processor operated by software, or microcode, or firmware, or a combination. In a further embodiment, the magnetic tape drive additionally comprises at least one decompressor, for example, embodied in the read channel(s) 18, 19, configured to decompress the data read by the read channel(s); and the search engine 30 is configured to search the decompressed data.

Referring additionally to FIG. 1, where the data is stored on a plurality of magnetic tape cartridges, data is read from magnetic tape cartridges in a plurality of magnetic tape drives 15, 27; and the data is searched by the plurality of magnetic tape drives, indicating matches of strings of the data, and the plurality of magnetic tape drives identify patterns of selected matches.

Magnetic tape drives conducting the searches of large databases of data stored on magnetic tape frees the host(s) for other work and places the searches in proximity to the databases. For example, the magnetic tape drives may be located in a library which houses the magnetic tape cartridges storing the database. Further, a number of magnetic tape drives can conduct the searches simultaneously. Both the proximity to the data and the number of magnetic tape drives in parallel allow the search to be conducted efficiently.

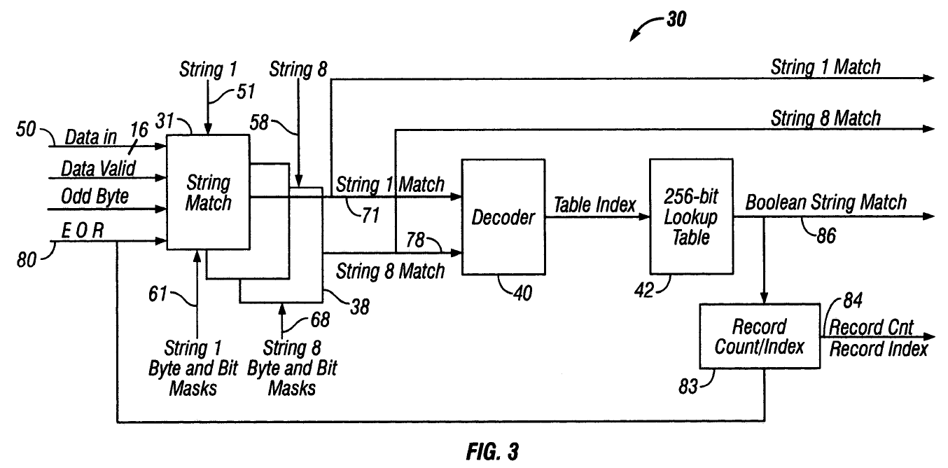

An embodiment of a search engine 30 in accordance with the present invention is illustrated in FIG. 3. A plurality of string comparison engines 31-38 are configured to search common data 50 in parallel and to indicate matches to search terms; and an identification engine 40, 42 is configured to identify patterns of the matches indicated by selected string comparison engines. The string comparison engines thus are able to search for different data strings in the same common data, and the identification engine allows combinations of those different data strings to be identified. In the example of FIG. 3, string comparison engines 31-38 search data and indicate matches to search terms supplied at inputs 51-58 and mask inputs 61-68, and supply outputs on lines 71-78 to indicate matches. Not all of the string comparison engines 31-38 are necessarily used in each instance. For example, the search may comprise 5 strings, so that only 5 of the, e.g. 8, string comparison engines may be utilized. A special mask input may identify the string comparison engines that are not utilized. The string comparison engine outputs 71-78 may, for example, comprise a “1” bit to indicate a match, and a “0” bit to indicate no match. Alternatively, multiple bits may be utilized to indicate matches or failures, and to additionally indicate that the string comparison engine was not utilized. The outputs may be supplied to the identification engine 40, 42 to identify patterns of the matches. An identified pattern match is indicated on line 86. Further the patterns may include and exclude selected string comparison engines. An end of record signal 80 may end a search of that record, and may operate the record counter and index logic 83 to provide the record count on line 84.

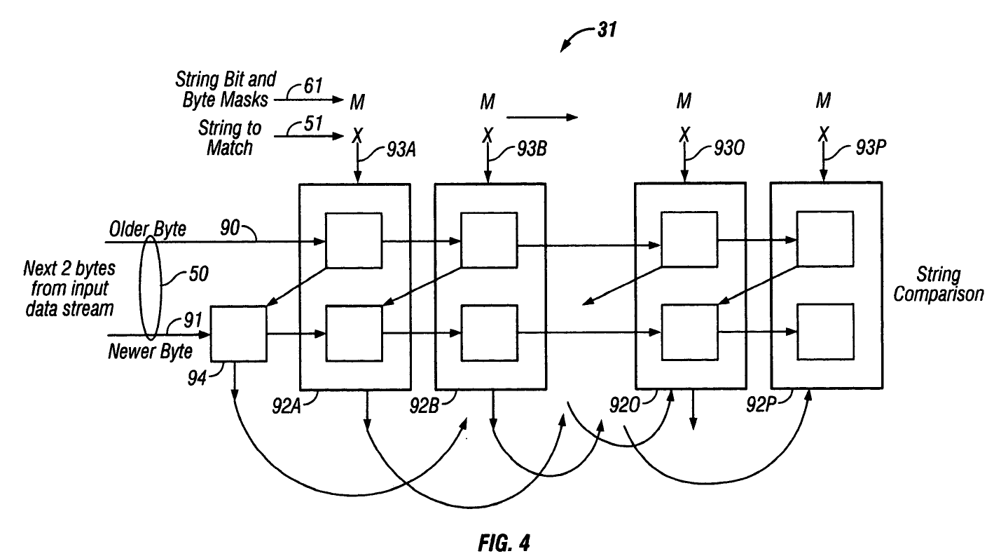

An embodiment of a string comparison engine (e.g. engine 31) is illustrated in FIG. 4. The string comparison engine searches data and indicates matches to search terms. In the example of FIG. 4, the string comparison engine is configured to search the data on a byte-by-byte basis, and is configured to search two consecutive bytes of the data in parallel. The input data 50 is two bytes wide 90, 91, and the flow of data for incoming bytes is left to right. In the example, 16 bytes are to be compared by 16 comparison blocks 92A-92P. Alternative arrangements can be envisioned by those of skill in the art. The older byte 90 of the incoming data is compared along the top row of the comparison blocks, and the newer byte 91 of the incoming data is compared along the bottom row of the comparison blocks.

Bit and byte masks 61 may be applied to modify specific search terms 51. The masks and search terms for each consecutive set of two bytes are applied at inputs 93A-93P to the comparison blocks 92A-92P. Examples of masks will be discussed subsequently.

The bytes to be searched for are compared in the string comparison blocks. The current byte is compared to the older byte, as byte 90, and the previous byte is compared to the newer byte, as byte 91. A match of both bytes results in a carry out of the first or second comparison blocks, and, in subsequent comparison blocks, a match of both bytes and the match carry in results in a carry out to the comparison block two blocks to the right. A first comparison block 94 only compares the first byte of the string to be matched to the newer byte of the incoming string. This allows a match to start at the second of the two bytes.

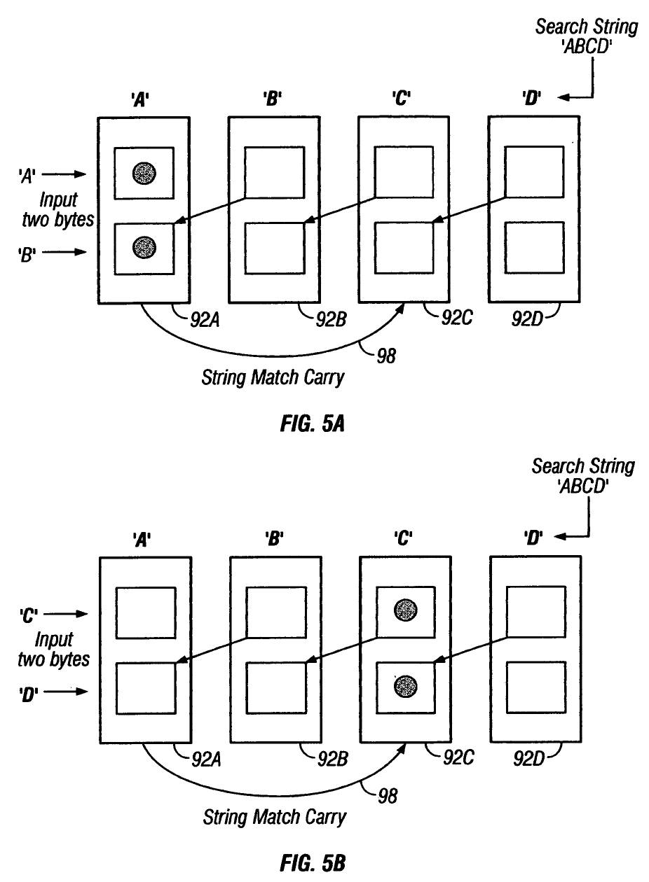

FIGS. 5A and 5B illustrate an example. Suppose the search is for the string “ABCD”, and the first two bytes into the string comparison engine are “AB”. As illustrated in FIG. 5A, bytes “AB” match in the first comparison unit 92A as depicted by the bullets in the boxes. This double match is carried two blocks to the right as depicted by the carry out 98, in preparation for the next two bytes. Referring to FIG. 5B, now, bytes “CD” match along with the carry in to the comparison block 92C. This string is now completely matched.

In the example, each comparison block works independently. For example, if the string to match was “THTHE” and the incoming byte is a “TH”, assuming that there was no match to the previous bytes, the only match will be at the first comparison block, since the carry in to the other comparison blocks will be off. When the second “TH” comes, there will be matches in the first and third comparison blocks. This allows strings to be continually matched no matter where in the sequence the characters are input.

In the example of FIG. 4, the string comparison blocks 92A-92P take in two bytes from the string 51 to match, two bytes 50 of the incoming data, and the bit and byte masks 61 for the comparison.

As an example, the bit mask may comprise an 8 bit value that could apply to all bytes in the string. This allows for case independent searches. Where there is a “1”, the bit must match. Where there is a “0”, this is a “don't care” condition. For example:

“11011111” bit mask would match any upper or lower case ASCII character.

“10111111” bit mask would match any upper or lower case EBCDIC character.

The byte mask, for example, is a 2 bit field for each byte in the string. The two bits may be encoded in the following manner:

“11”—Byte must match exactly, bit for bit.

“10”—Byte must match, but based on the bit mask for this string.

“01”—byte must exist in this location, but its value is a “don't care”. This is as though the bit mask were all zeros.

“00”—Not a valid byte in this position. Used when the string to search for contains fewer bytes than the maximum length search string. Note that bytes cannot be skipped, as the carry in will not propagate. Therefore, this byte mask will signal the end of a search.

An example of the equations for VLSI logic used to match the strings:

```
    Str0EQ <= CmpEn AND
    ((str0=data0) and (bytemask0=”11”)) OR -- exact
match
    (((str0 AND bitmask) = (data0 AND bitmask)) AND
(bytemask0=”10”)) OR (bytemask0=”01”); -- don't care
    Str1EQ <= CmpEn AND NOT(OddByte) AND -- cannot
compare if 2^{nd} byte not valid
    ((str1=data1) and (bytemask1=”11”)) OR -- exact
match
    (((str1 AND bitmask) = (data1 AND bitmask)) AND
(bytemask1=”10”)) OR (bytemask=”01”) -- don't care
```

There are two cases for determining the match within the comparison block. In one case there is a carry in and the first byte matches, but not the second. Or, both bytes match. In the first case, the carry out will not propagate, but if the second byte was not a valid byte to search for, the match could occur here:

MatchGREQ1<=Str0EQ AND NOT(str1EQ) AND carryin; --match thru the first byte.

MatchGTEQ2<=Str0EQ AND Str1EQ AND carryin; --match thru both bytes.

We can determine if there was a match by also using the flag from the next byte to determine if it was valid, as the flag from the older byte box of comparison block 92A to the newer byte comparison block 94 of FIG. 4. The match could end at the first byte, or the second if the following byte is not valid.

```
    Strmatch <= ((bytemask1=”00”) AND MatchGTEQ1) OR --
string match ending at str 0.
    (NOT(nextvalid) AND MatchGEQ2); -- string match
ending at str 1.
```

The carry out to the next comparison block is the latched version of MatchGTEQ2. This signifies both bytes matched and the carry in was active.

If any strmatch from any of the comparison blocks is active, then the string match for the overall string is set. These string matches go into the identification engine 40, 42 of FIG. 3 for identifying the string match patterns.

In the example of FIG. 3, the identification engine 40, 42 comprises a decoder 40 and a Boolean look up table 42. Those of skill in the art recognize that alternative identification engines may be employed.

The Boolean look up table 42 is able to perform complex pattern matching. This is a table that contains 2**N bits, where N is the number of strings that can be searched for. In the instant example, there is a maximum of 8 strings that can be searched for, so the table is 2**8, or 256 bits. Each location of the table can be envisioned as being encoded by 8 bits. Thus, bit 0 is “00000000”, and location 3 is “00000011”.

To create a Boolean equation, for example, of:
(str1 AND str2) OR (str3 AND str4),
to determine if there are any matches, the look up table 42 is filled with a “1” in each location where both bits 1 and 2 are a “1” and also with a “1” where both bits 3 and 4 are a “1”. Thus, in this case to match str1 AND str2, location 3, 7, 11, etc. will all be filled with a “1”. And to match str3 AND str4, locations 12 thru 15, 28-31, etc. would be filled with a “1”.

Now the strmatch bits from the output 71-78 of each string comparison engine 61-68 is decoded by decoder 40. This decoded value is used as an index into the Boolean look up table 42. If that location contains a “1”, then the Boolean equation has been satisfied.

As an example, suppose that the following Boolean equation is to be searched for:
(str1 AND NOTstr2) OR (NOTstr3 AND NOTstr4),

A “1” would be entered in each location where bit 1 is a “1” and bit 2 is a “0”; and a “1” in each location where bit 4 is a “0” and bit 5 is a “0”. So for the str1 and not str2, any location of the following “xxxxxx01” in the 256 bit look up table would contain a “1”; and for not str4 and not str5, any location of the following “xxx00xxx” would contain a

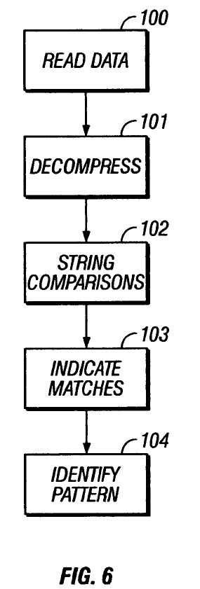

A service method in accordance with an embodiment of the present invention is depicted by the flow chart of FIG. 6. In step 100, the data to be searched is read from the database. For example, where the data is stored on a plurality of magnetic tape cartridges, data is read from magnetic tape cartridges in a plurality of magnetic tape drives. If the data is compressed, in step 101, the data is decompressed prior to searching; such that said searching comprises searching said decompressed data. In step 102, the data is searched by the plurality of magnetic tape drives, and, in step 103, the magnetic tape drives indicate matches of strings. In step 104, the plurality of magnetic tape drives identify patterns of selected matches. Alternatively, the service method may comprise a single magnetic tape drive. Still alternatively, the service method and/or logic may be employed with other types of data storage drives, such as HDD or optical disk data storage drives.

Those of skill in the art will understand that changes may be made with respect to the method and operation of the described and the illustrated components. Further, those of skill in the art will understand that differing specific component arrangements may be employed than those illustrated herein.

While the preferred embodiments of the present invention have been illustrated in detail, it should be apparent that modifications and adaptations to those embodiments may occur to one skilled in the art without departing from the scope of the present invention as set forth in the following claims.

What is claimed is:

1. Logic comprising:
a plurality of string comparison engines configured to search data and to indicate matches to search terms; and
an identification engine configured to identify patterns of said matches indicated by selected said string comparison engines.

2. The logic of claim 1,
wherein said plurality of string comparison engines are configured to search a common set of data in parallel.

3. The logic of claim 1,
wherein at least one of said plurality of string comparison engines comprises at least one mask configured to modify specific search terms.

4. The logic of claim 1,
wherein at least one of said plurality of string comparison engines is configured to search said data on a byte-by-byte basis.

5. The logic of claim 4,
wherein said at least one string comparison engine is configured to search said bytes of data employing a bit mask for each byte and a byte mask.

6. The logic of claim 4,
wherein said at least one string comparison engine is configured to search two consecutive bytes of said data in parallel.

7. The logic of claim 1,
wherein said identification engine comprises a Boolean look-up table.

8. A magnetic tape drive, comprising:
a tape drive system for moving a magnetic tape longitudinally;
at least one read channel configured to read data recorded on a magnetic tape as the tape is moved longitudinally by said tape drive system; and
a search engine configured to search data read by said at least one read channel and to identify matches of strings of data to search terms.

9. The magnetic tape drive of claim 8,
additionally comprising at least one decompressor configured to decompress said data read by said at least one read channel; and
said search engine is configured to search said decompressed data.

10. The magnetic tape drive of claim 8, wherein said search engine comprises:
a plurality of string comparison engines configured to search said data and to indicate matches to search terms; and
an identification engine configured to identify patterns of said matches indicated by selected said string comparison engines.

11. The magnetic tape drive of claim 10,
wherein said plurality of string comparison engines are configured to search a common set of data in parallel.

12. The magnetic tape drive of claim 11,
wherein at least one of said plurality of string comparison engines comprises at least one mask configured to modify specific search terms.

13. The magnetic tape drive of claim 11,
wherein at least one of said plurality of string comparison engines is configured to search said data on a byte-by-byte basis.

14. The magnetic tape drive of claim 13,
wherein said at least one string comparison engine is configured to search said bytes of data employing a bit mask for each byte and a byte mask.

15. The magnetic tape drive of claim 13,
wherein said at least one string comparison engine is configured to search two consecutive bytes of said data in parallel.

16. The magnetic tape drive of claim 10,
wherein said identification engine comprises a Boolean look-up table.

17. A service method of searching data, comprising:
searching a common set of data in parallel and indicating matches of strings of said data to search terms; and
identifying patterns of selected said matches.

18. The service method of claim 17, additionally comprising:
decompressing said data prior to searching; such that said searching comprises searching said decompressed data.

19. The service method of claim 18, wherein said data comprises data stored on a plurality of magnetic tape cartridges, and said method additionally comprising:
reading said data from magnetic tape cartridges in a plurality of magnetic tape drives; and
said searching and said identifying comprise searching said data and identifying said patterns by said plurality of magnetic tape drives.

20. The service method of claim 17,
wherein said identifying comprises looking-up patterns of selected said matches in a Boolean look-up table.
